(19) United States
(12) Patent Application Publication
(10) Pub. No.: US 2008/0059803 A1
(43) Pub. Date: Mar. 6, 2008

(54) Method for the authentication of printed document

(75) Inventor: Tien-Chun Tung, Taipei City (TW)

Correspondence Address: TUNG, TIEN-CHUN, 20525 Via Talavera, Yorba Linda, CA, 92887, US

(73) Assignee: ZEON CORPORATION

(21) Appl. No.: 11/516,932

(22) Filed: Sep. 6, 2006

(51) Int. Cl. H04L 9/00

(52) U.S. Cl. 713/176

(57) ABSTRACT

The present invention intends to provide a method of generating document authentication data and authenticating documents by determining whether or not an authenticated document in question is consistent with the original document. The present invention provides an improved method of authenticating a digital or a printed document, capable of verifying the authentication of the document without its original document. The document authentication data are collected, verified, and stored in an authentication center; and the data( such as, page digests) can be retrieved and compared with the data regenerated from the printed document. The improved method of the present invention can greatly reduce the cost, in terms of times and money, of authenticating the contents of printed matters; and improve the safety of document exchanges.

### FIELD OF THE INVENTION

The present invention mainly relates to a method for the authentication of document by generating, storing, and verifying the document authentication data; and more particularly to a method for generating document authentication data that can be used to verify the contents of a document.

### BACKGROUND OF THE INVENTION

In modem societies, most of the documents are prepared and processed by using electronic devices. Although digital documents can be signed electronically, there is still no effective ways to sign and protect printed documents. Since printouts, such as diploma (certificates) or agreements (contracts), can be scanned, altered, and printed again easily by an unauthorized person, it is very difficult to distinguish a true copy from a false copy of a document.

The present invention intends to provide a method of authenticating either digital or printed documents; and later on to verify if the documents have been amended or altered. In short, a document authentication data are collected, signed, and stored in an authentication center; and later on can be retrieved and compared with the data regenerated from the document to verify if the document has been altered. The present invention can greatly reduce the cost, in terms of times and money, of authenticating and verifying of the document content; and improve the safety of document exchanges.

### SUMMARY OF THE INVENTION

It is a primary objective of the present invention to overcome the shortcomings of the prior art by providing a method for generating document authentication data and storing the authentication data in a authentication center so that the method of the invention can verify the authenticity of the document.

It is another objective of the present invention to provide an improved method that is capable of authenticating a digital or a printed document, and verifying the authentication of a sealed document page.

It is another objective of the present invention to provide an improved method of authenticating a digital or a printed document, capable of verifying the authentication of the document without its original document.

According to one of preferred examples of the present invention, the method for generating document authentication data comprises the following steps:
(1) providing a document authentication system, wherein electronic operating devices are provided in the system to proceed the authentication, the electronic operating devices further includes a document authentication unit and an authentication center for the authenticating of the document;(2) opening a digital document that includes at least one text document page, and selecting a text document page to be authenticated;
(3) collecting visible, printable, correct, and properly encoded text document data from the selected text document page in step (2) via the document authentication unit according to a user's requirements; and either highlighting the collected text document data of the whole text document page, or dividing the collected text document data into segments and highlighting each segment differently;
(4) determining whether or not to authenticate the highlighted text document data of the selected text document page in step (3) through the document authentication unit, if not, the system will go to step (6), or otherwise it will proceed to step (5);
(5) generating a digest map of the selected text document page, and calculating a page digest (or segment digests) according to the collected (highlighted) text data in step (3) via the document authentication unit;
(6) determining whether or not to proceed another text document page, if yes, then the system will go to step (3), or otherwise it will proceed to step (7);
(7) determining whether or not to create an authentication data of the document, based on the page (or segment) digests and digest maps generating in previous steps via the document authentication unit, if not, the system will go to step (9), or otherwise it will proceed to step (8);
(8) signing the authentication data created in step (7) via the document authentication unit, submitting the signed authentication data to the authentication center, receiving a seal issued and signed by the authentication center, and inserting, the seal in each page of the authenticated document above; and
(9) terminating the document page authenticating process.

A method for verifying the authenticity of a document, capable of determining the authentication of the document without its original document, in accordance with another preferred example of the present invention comprises the following steps:

(1) providing a document authentication system, wherein electronic operating devices are provided in the system to proceed the authentication, the electronic operating devices further includes a document authentication unit and an authentication center for the verification of the document;

(2) determining whether or not the document is sealed by the foregoing method, if not, the system will go to step (17), or otherwise it will proceed to step (3);

(3) logging on to the authentication center, whose address is specified in the seal, via the document authentication unit, and utilizing a document ID, which is also specified in the seal, to locate the document in the authentication center, and confirming the signature of the signer(s) of the authentication data of the document;

(4) selecting a sealed document page to be verified;

(5) using a page number, specified in the seal, to obtain the digest map of the selected document page from the authentication center;

(6) determining whether or not the document is digital format, if yes, the document authentication system will proceed to step (7), or otherwise the system will proceed to step (8);

(7) opening the digital document if it is necessary, and using the obtained digest map to locate document text data on the selected document page via the document authentication unit, and calculating the page digest (or segment digests) of the selected document page according to the digest map, and then go to step (15)

(8) determining whether or not to capture page images of the selected document page, if yes, the system will go to step (9), or otherwise the system will proceed to step (10)

(9) scanning (or use other image capture devices) the selected document page of the printed document, opening the page image captured above, and then using the digest map to highlight the useful text data on the page image (each segment will be highlighted differently) via the document authentication system, and the system goes to step (11);

(10) printing (or displaying) the digest map, and overlapping it with the printed selected document page for highlighting the useful text data on the document page (each segment will be highlighted differently);

(11) determining whether or not to verify the whole document page, if yes, the system will go to step (13), or otherwise if the user decides to verify specific segments only, the system will proceed to step (12);

(12) inputting (either directly inputting or using an Optical Character Recognition system) all (only) the highlighted characters of the specified segments by using the electronic operating device, and proceeding to step (14);

(13) inputting (either directly inputting or using an Optical Character Recognition system) all the highlighted characters of the selected page by utilizing the electronic operating device;

(14) calculating the digests, either the page digest or the segment digests, of the characters inputted above via the document authentication unit;

(15) submitting the calculated page digest (or the calculated segment digests) to the authentication center through the document authentication unit, and comparing the submitted digest(s) with the digest(s) of the selected document page stored in the authentication center, if they are the same, the highlighted characters of selected document page have not altered or amended, or otherwise the selected document page has altered or amended;

(16) determining whether or not to verify another document page via the document authentication unit, if yes, the system will go to step (4), or otherwise the system will proceed to step (17); and

(17) terminating the verification process.

### Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a schematic view of an application of a method for generating document authentication data in accordance with a preferred embodiment of the present invention; and

FIG. 2 is a schematic view of an application of a method for verifying the authenticity of a document in accordance with a preferred embodiment of the present invention.

FIG. 3 is a flow chart of a method for generating document authentication data in accordance with a preferred embodiment of the present invention;

FIG. 4 is a flow chart of a method for authenticating a document in accordance with a preferred embodiment of the present invention;

### DETAILED DESCRIPTION OF THE PREFERRED EMBODIMENTS

The above and other technical characteristics and advantages of the present invention will become apparent from the following detailed taken with the accompanying drawings.

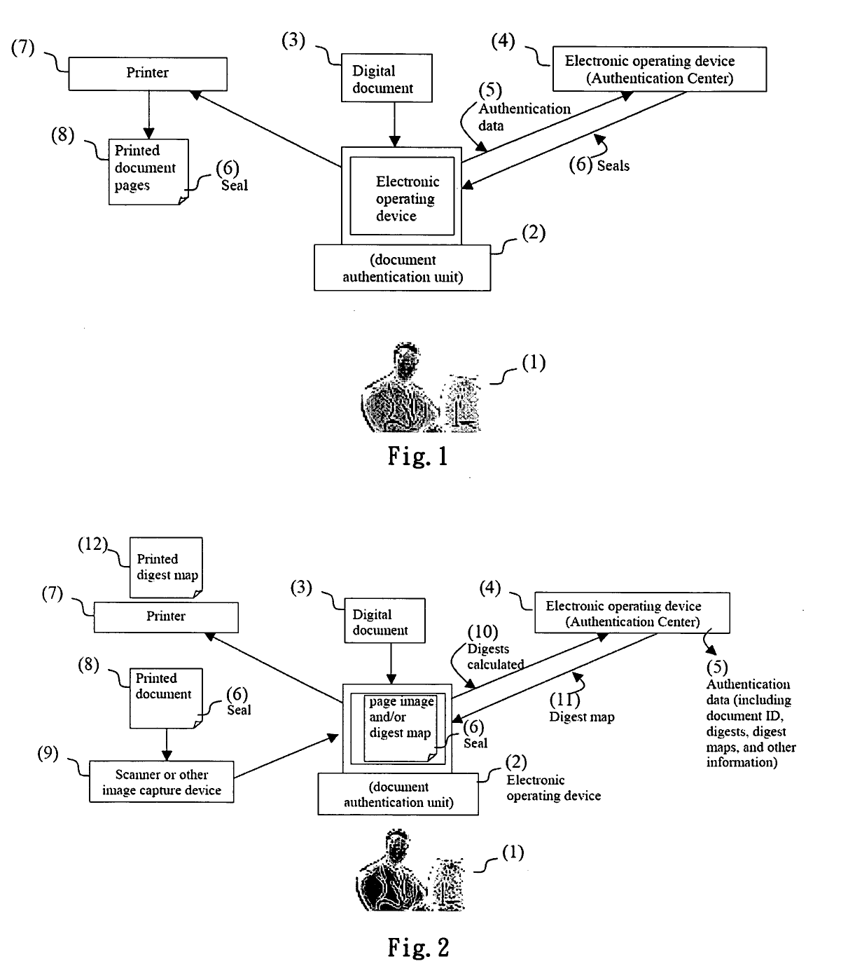

Referring to FIG. 1 for an application of a method for generating document authentication data in accordance with a preferred embodiment of the present invention. The method of the present invention comprises steps of a user (1) uses an electronic operating device (2) to open a digital document (3), and the electronic operating device (2) includes a document authentication unit. The electronic operating device (2) is connected to another electronic operating device (4) which includes an authentication center, and the electronic operating device (2) may also be connected to printer (7); wherein the document authentication unit highlights and collects useful text data from selected pages of the digital document (3) to creates digests and digest maps of the selected pages for the generation of the authentication data (5) for the digital document (3).

The foregoing digests are calculated and obtained by an irreversible unique algorithm, and the digest maps are used in the verification process to find positions of the useful text data which are used to calculate the digests. Once the user (1) completes the authentication of digital document (3), the document authentication unit will sign the authentication data (5) by using signers' digital IDs, and submit the signed authentication data (5) to the authentication center (4). Seals (6) received from the authentication center (4) will then be inserted in every authenticated page of the digital document (3), and optionally, the user (1) can use the document authentication unit (2) to generate printouts (8) of the digital document (3) through connected printer with seals (6) on authenticated pages.

Referring to FIG. 2 for a schematic view of an application of a method for verifying the authenticity of a document in accordance with another preferred embodiment of the present invention, the method comprises a user (1) uses a electronic operating device (2) to verify the authenticity of sealed document, either a digital document (3) or a printed document (8). The electronic operating device (2) of the present invention includes a document authentication unit and is optionally connected to printer (7) and/or scanner (9), wherein the user (1) or the document authentication unit determines whether or not the document, either in a digital format (3) or a printed format (8), is sealed by the foregoing method, if no, the verification process will be terminated, or the document authentication unit (2) will log on the authentication center (4) whose location (address) is specified in the seal (6), and will use the document ID, also specified in the seal (6), to locate the signed authentication data of the document in the authentication center, and will validate the signature of the signer of the authentication data and terminate the verification process if the signature is invalid.

The user (1) selects a sealed page to be verified and uses a page number, specified in the seal (6) on the selected page, to obtain a digest map (11) of the selected page from the authentication center (4). In order to verify a printed document (8), the user can capture the image of the selected page, either use a scanner (9) or use other image capture devices, and open the selected page via the document authentication unit (2). The digest map (11) obtained from the authentication center (4) will then be used to highlight useful text data on the selected page, it can either print the digest map (12) and overlap it with the original printed page (8), or display the digest map on top of the selected page via the document authentication unit, and if it is necessary, the segments are highlighted differently.

Then the user inputs, either directly input or use an Optical Character Recognition system, the highlighted useful text data of the whole page or only the specific segments, via the document authentication unit, and the digest(s) of the inputted characters, either the page digest or the digests of specific segments, is(are) calculated. The document authentication unit (2) will submit the calculated digest(s) (10) to the authentication center (4), and the authentication center will then compare the submitted digest(s) with comparable digest(s)(5) stored in the authentication center. If the result is not the same, it indicates that the selected page has been altered or amended, or when the result is comparable, it means that the selected has not been altered. Then the user (1) determines, via the document authentication unit, whether or not to select and verify another sealed document page. If no, the verification process is terminated, or otherwise, the verification procedure is repeated.

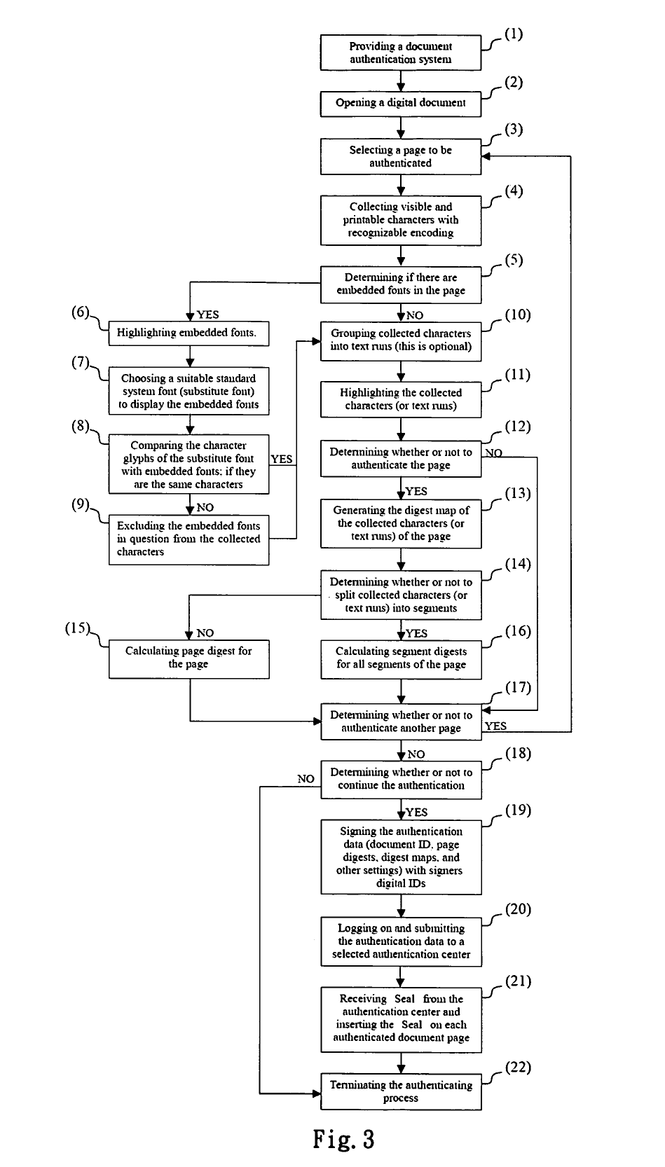

Referring to FIG. 3 for a flow chart of a method for generating document authentication data and storing the authentication data in an authentication center, capable of verifying the authenticity of the document.

The method for generating document authentication data in accordance with another preferred example of the present invention comprises the following steps:

(1) providing a document authentication system, wherein electronic operating devices are provided in the system to proceed an authentication process, the electronic operating devices further includes a document authentication unit, an authentication center for authenticating of a document, and other optional devices such as, a printer;

(2) opening a digital document that includes at least one text document page via the document authentication unit;

(3) selecting a text document page to be authenticated via the document authentication unit;

(4) collecting visible and printable characters with recognizable encodings from the selected text document page via the document authentication unit according to a user's requirements;

(5) determining if there are embedded fonts in the selected text document page via the document authentication unit; if yes, the system will go to step (6), if not, the system will proceed to step (10);

(6) highlighting all the characters of embedded fonts on selected text document page via the document authentication system;

(7) choosing a suitable standard system font as a substitute font, and using the substitute font to display all the characters of embedded fonts via the document authentication unit;

(8) comparing displayed character glyphs of the substitute font with original embedded fonts via the document authentication unit, if they are the same characters, the system will go to step (10), if not, the system will proceed to step (9);

(9) excluding characters of the embedded fonts with questionable glyphs from the collected characters in step (4) via the document authentication unit;

(10) optionally grouping collected characters into text runs via the document authentication unit; or optionally setting preferences such as, exclude or include “space” or punctuation marks in the collected character;

wherein a text run may combine multiple characters into one single “run”, a single bounding box of the text run with a character count can be used to represent multiple character bounding boxes, therefore can be used to reduce the size of a digest map.

(11) highlighting the collected characters or the text runs generated in step (10) via the document authentication unit, wherein the collected characters are the characters of the selected text document page to be authenticated;

(12) determining whether or not to authenticate the selected text document page via document authentication unit, if yes, the system will go to step (13), if no, the system will proceed to step (17);

(13) generating a digest map of the collected characters (or the text runs) of the selected text document page via the document authentication unit;

wherein the “digest map” mainly includes a sequence of text location information such as, character (or phrases, lines) bounding boxes on the document page, and it may also contain other marks such as, character counts of bounding boxes. The digest map is used to locate the text data in a sequence, for helping, either direct or Optical Character Recognition, text inputting that is used to computerize page digest or segment digests.

(14) determining whether or not to split the collected characters (or the text runs) into smaller segments, in which each segment will be highlighted differently, via the document authentication unit, if yes, the system will go to step (16), if no, the system will proceed to step (15);

(15) calculating a digest of all the collected characters (or the text runs) of the selected text document page via the document authentication unit; and then proceeding to step (17);

wherein the “digest” (or a message digest) utilizes algorithms (an algorithm is a statement of a step-by-step procedure for solving a problem), such as, the widely used Message-Digest algorithm 5 (MD5) and Secure-Hash Algorithm 1 (SHA1), which take an input message of an arbitrary length and produce an output “fingerprint” or a “message digest”. As a matter of fact, it is impractical to produce two messages having the same message digest, or to produce any message having a given pre-specified target message digest;

(16) calculating the digests for all the segments of the selected text document page via document authentication unit according to the collected characters (or the text runs) in each segment;

(17) saving the calculated digests and the digest map of the selected text document page, and then determining whether or not to authenticate another text document page, if yes, the document authentication unit will go to step (3), if no, it will proceed to step (18);

(18) determining whether or not to continue the authentication process, if no, the document authentication unit will go to step (22), if yes, the system will proceed to step (19);

(19) digitally signing an authentication data collected in previous steps via the document authentication unit;

wherein the authentication data mainly includes a document ID (a unique identifier of a document), and the digests, the digest maps of all authenticated text document pages, together with other optional settings, such as grouping and determining whether or not to use the punctuation marks;

(20) logging on and submitting the signed authentication data to a selected authentication center, via the document authentication unit;

(21) receiving a seal from the selected authentication center via the document authentication unit; and inserting the seal on each authenticated document page,

wherein the seal, inserted by the document authentication unit on each authenticated document page, mainly contains the document ID, a page number, an address of a authentication center, and possibly with other information. The seal must also appear on the printouts of the digital document; and

(22) terminating the authenticating process.

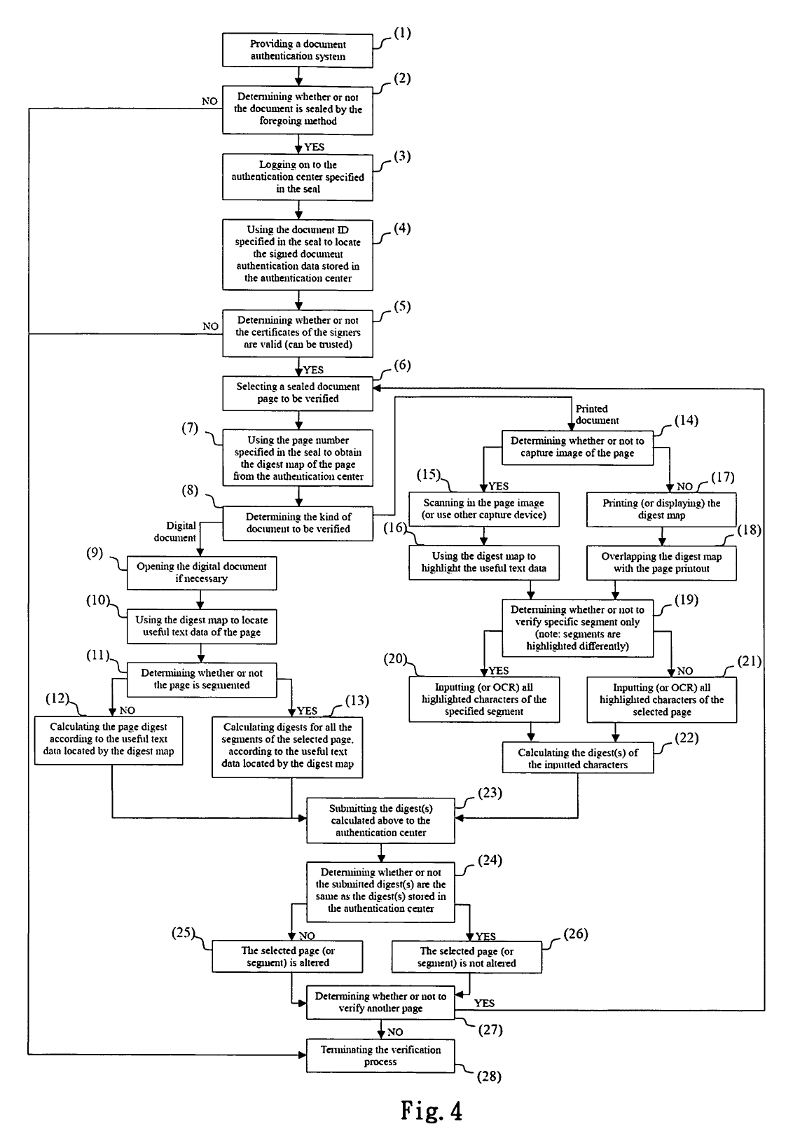

Referring to FIG. 4 for a flow chart of a method of verifying the authenticity of a sealed document page. The present invention provides an improved method that can verify any type of sealed document's authentication ( either a digital or a printed format) without the original document data. In other words, the improved method for verifying a sealed document in accordance with another preferred example of the present invention can identify and determine whether or not an authenticated document in question is consistent with an original document (i.e. it has not altered), the method comprises the following steps:

(1) providing a document authentication system, wherein electronic operating devices are provided in the system to proceed a verification of a sealed document, the electronic operating devices further includes a document authentication unit, an authentication center for verifying the sealed document, and may include other optional devices such as, a printer or a scanner;

(2) determining whether or not a document is sealed by the foregoing method, if there is no seals on document pages, the document is detected as a unauthenticated document, the document authentication unit will proceed to step (28), if there is seal on the document page, the system will proceed to step (3);

(3) logging on to an authentication center, whose location (address) is specified in the seal on authenticated document pages, via the document authentication unit;

(4) utilizing a document ID; which is specified in the seal on the authenticated document pages, to find a signed document authentication data stored in the authentication center, via the document authentication unit;

(5) validating a signature of a signer in respect to the signed document authentication data, if the signature is valid (legitimated), the document authentication unit will go to step (6), or otherwise, the system will proceed to step (28);

(6) selecting a sealed (authenticated) document page to be verified by using the document authentication unit;

(7) using a page number, specified in the seal on the selected document page, to obtain a digest map of the selected document page from the authentication center;

(8) determining what kind of document is to be verified, if the document is a digital document, the document authentication system will go to step (9), or if the document is a printed document, the system will proceed to step (14);

(9) opening the digital document if it is necessary;

(10) using the digest map, obtained from the authentication center, to locate (highlight) useful text data on the selected document page via the document authentication unit;

(11) determining whether or not the selected document page is split into multiple segments, if yes, the document authentication unit will go to step (13), if not, the system will proceed to step (12);

(12) calculating a page digest of the selected document page according to the useful text data located (highlighted) by using the digest map in step (10), and the document authentication unit proceeds to step (23);

(13) calculating the digests for all segments of the selected document page, according to the useful text data located (highlighted) in each segment via the document authentication unit, the document authentication unit proceeds to step (23);

(14) determining whether or not to capture an image of the selected document page, if yes, the document authentication unit will go to step (15), if no, the system will go to step (17);

(15) utilizing a scanner (or uses other image capturing devices) to generate the image of the selected document page, and opening a captured image via the document authentication unit;

(16) using the digest map, obtained in step (7), to highlight the useful text data on the image (different segments are highlighted differently) via the document authentication unit, the system proceeds to step (19);

(17) printing (or displaying) the digest map obtained in step (7) via the document authentication unit;

(18) overlapping the printed (displayed) digest map in step (17) with the printed document for highlighting the location of useful text data;

(19) determining whether or not to verify specific segments of the selected document page (note: different segments are highlighted differently), if yes, the document authentication unit will go to step (20), if no, the system will proceed to step (21);

(20) inputting, either directly inputting or using an Optional Character Recognition system, all (or specified) highlighted characters in the specific segments of the selected document page by using the document authentication system, and proceeding to step (22) of the procedure;

(21) inputting, either directly inputting or using the Optional Character Recognition system, all the highlighted characters of the selected document page by using the document authentication system;

(22) calculating the digests, either the page digest or the specific segment digests, of the inputted highlighted characters by using the document authentication system;

(23) submitting the digest(s) calculated in above steps—step (12), (13), or (22), to the authentication center via the document authentication unit;

(24) determining whether or not the submitted digests in step (23) are the same as the comparable digests stored in the authentication center, if yes, the document authentication unit will go to step (26), if not, the system will go to step (25);

(25) confirming the highlighted useful text data in the selected document page, or in the specific segments of the selected document page, has been altered, and the document authentication unit will go to step (27);

(26) confirming that the highlighted text data in the selected page, or in the specific segments of the selected page, have not been altered;

(27) determining whether or not to verify the authenticity of another document page, if yes, the document authentication unit will go to step (6), or otherwise, the system will proceed to step (28); and

(28) terminating the verification process.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for generating document authentication data and storing the authentication data in an authentication center, capable of verifying an authentication of a document, comprising the following steps:
(1) providing a document authentication system, wherein electronic operating devices are provided in the system to proceed an authentication process, the electronic operating devices further includes a document authentication unit, an authentication center for authenticating of a document;
(2) opening a digital document that includes at least one text document page via the document authentication unit;
(3) selecting a text document page to be authenticated via the document authentication unit;
(4) collecting visible and printable characters with recognizable encodings from the selected text document page in step (3) via the document authentication unit according to a user's requirements;
(5) determining whether there are embedded fonts in the selected text document page via the document authentication unit, if there are, the system will go to step (6), if there are not, the system will proceed to step (10);
(6) highlighting all the characters of embedded fonts on selected text document page via the document authentication system;
(7) choosing a suitable standard system font as a substitute font, and using the substitute font to display all the characters of embedded fonts via the document authentication unit;
(8) comparing displayed character glyphs of the substitute font with original embedded fonts via the document authentication unit, if they are the same characters, the system will go to step (10), if they are not, the system will proceed to step (9);
(9) excluding characters of the embedded fonts with questionable glyphs from the collected characters in step (4) via the document authentication unit;
(10) optionally grouping collected characters into text runs via the document authentication unit, or optionally setting preferences such as, to exclude or include a “space” or punctuation marks in the collected character;
(11) highlighting the collected characters or the text runs generated in step (10) via the document authentication unit, wherein the collected characters are the characters of the selected text document page to be authenticated;
(12) determining whether or not to authenticate the selected text document page via document authentication unit, if yes, the system will go to step (13), if no, the system will proceed to step (17);
(13) generating a digest map of the collected characters (or the text runs) of the selected text document page via the document authentication unit;
(14) determining whether or not to split the collected characters (or the text runs) into smaller segments, in which each segment will be highlighted differently, via the document authentication unit, if yes, the system will go to step (16), if no, the system will proceed to step (15);
(15) calculating a digest of all the collected characters (or the text runs) of the selected text document page via the document authentication unit; and then proceeding to step (17);
(16) calculating the digests for all the segments of the selected text document page via document authentication unit according to the collected characters (or the text runs) in each segment;
(17) saving the calculated digests and the digest map of the selected text document page, and then determining whether or not to authenticate another text document page, if yes, the document authentication unit will go to step (3), if no, it will proceed to step (18);
(18) determining whether or not to continue the authentication process, if no, the document authentication unit will go to step (22), if yes, the system will proceed to step (19);
(19) digitally signing an authentication data collected in previous steps via the document authentication unit;
(20) logging on and submitting the signed authentication data to a selected authentication center, via the document authentication unit;
(21) receiving a seal from the selected authentication center via the document authentication unit; and inserting the seal on each authenticated document page; and
(22) terminating the authenticating process.

2. The method of claim 1, wherein the optional devices can comprise a printer connected to the electronic operating devices.

3. The method of claim 1, wherein the electronic operating devices can be a personal computer, such as a notebook computer or a PDA.

4. The method of claim 1, wherein the authentication center comprises a personal computer or a computer workstation.

5. The method of claim 1, wherein the text run in step (10) comprises multiple characters in one single run that can be sued to reduce a size of a digest map.

6. The method of claim 1, wherein the digest map is utilized to locate the text document data, it can comprise a sequence of text location information, such as character or phrase bounding boxes on the selected text document page, and other marks such as, character count of bounding boxes.

7. The method of claim 1, wherein the authentication data in step (19) comprises a document ID, the digests and digest maps of all authenticated text document pages together with other optional settings.

8. The method of claim 1, wherein the seal in step (21) includes the document ID, a page number and an address of the authentication center.

9. The method of claim 1, wherein the seal will be appeared on every page of printed verified text document

10. A method for verifying a sealed document, capable of identifying and determining whether or not an authenticated document in question is consistent with an original document, the method comprises the following steps:
(1) providing a document authentication system, wherein electronic operating devices are provided in the document authentication system to proceed a verification of a sealed document, the electronic operating devices further includes a document authentication unit, an authentication center for verifying the sealed document, and it can include other optional devices;
(2) determining whether or not a document is sealed by the foregoing method, if there is no seals on document pages, the document is detected as a unauthenticated document, the document authentication unit will proceed to step (28), if there is seal on the document page, the system will proceed to step (3);
(3) logging on to an authentication center, whose location (address) is specified in the seal on authenticated document pages, via the document authentication unit;
(4) utilizing a document ID, which is specified in the seal on the authenticated document pages, to find a signed document authentication data stored in the authentication center, via the document authentication unit;
(5) validating a signature of a signer in respect to the signed document authentication data, if the signature is valid (legitimated), the document authentication unit will go to step (6), or otherwise, the system will proceed to step (28);
(6) selecting a sealed (authenticated) document page to be verified by using the document authentication unit;
(7) using a page number, specified in the seal on the selected document page, to obtain a digest map of the selected document page from the authentication center;
(8) determining what kind of document is to be verified, if the document is a digital document, the document authentication system will go to step (9), or if the document is a printed document, the system will proceed to step (14);
(9) opening the digital document if it is necessary;
(10)using the digest map, obtained from the authentication center, to locate (highlight) useful text data on the selected document page via the document authentication unit;
(11)determining whether or not the selected document page is split into multiple segments, if yes, the document authentication unit will go to step (13), if not, the system will proceed to step (12);
(12)calculating a page digest of the selected document page according to the useful text data located (highlighted) by using the digest map in step (10), and the document authentication unit proceeds to step (23);
(13)calculating the digests for all segments of the selected document page, according to the useful text data located (highlighted) in each segment via the document authentication unit, the document authentication unit proceeds to step (23);
(14)determining whether or not to capture an image of the selected document page, if yes, the document authentication unit will go to step (15), if no, the system will go to step (17);
(15)utilizing a scanner (or uses other image capturing devices) to generate the image of the selected document page, and opening a captured image via the document authentication unit;
(16)using the digest map, obtained in step (7), to highlight the useful text data on the image (different segments are highlighted differently) via the document authentication unit, the system proceeds to step (19);
(17)printing (or displaying) the digest map obtained in step (7)via the document authentication unit;
(18)overlapping the printed (displayed) digest map in step (17) with the printed document for highlighting the location of useful text data;
(19)determining whether or not to verify specific segments of the selected document page, if yes, the document authentication unit will go to step (20), if no, the system will proceed to step (21);
(20)inputting, either directly inputting or using an Optional Character Recognition system, all (or specified) highlighted characters in the specific segments of the selected document page by using the document authentication system, and proceeding to step (22) of the procedure;
(21)inputting, either directly inputting or using the Optional Character Recognition system, all the highlighted characters of the selected document page by using the document authentication system;
(22)calculating the digests, either the page digest or the specific segment digests, of the inputted highlighted characters by using the document authentication system;
(23)submitting the digest(s) calculated in above steps (12), (13), or (22), to the authentication center via the document authentication unit;
(24)determining whether or not the submitted digests in step (23) are the same as the comparable digests stored in the authentication center, if yes, the document authentication unit will go to step (26), if not, the system will go to step (25);
(25)confirming the highlighted useful text data in the selected document page, or in the specific segments of the selected document page, has been altered, and the document authentication unit will go to step (27);
(26)confirming that the highlighted text data in the selected page, or in the specific segments of the selected page, have not been altered;
(27) determining whether or not to verify the authenticity of another document page, if yes, the document authentication unit will go to step (6), or otherwise, the system will proceed to step (28); and
(28)terminating the verification process.

11. The method of claim 10, wherein the optional devices can comprise a printer or a scanner connected to the electronic operating devices.

12. The method of claim 10, wherein the electronic operating devices can be a personal computer, such as a notebook computer or a PDA.

13. The method of claim 10, wherein the authentication center comprises a personal computer or a computer workstation.

14. The method of claim 10, wherein the image capture devices is a scanner.

15. A method for generating document authentication dada, comprising an electronic operating device having a document authentication unit, wherein the electronic operating device is connected to a second electronic operating device comprising an authentication center, the method comprising the steps of:
(1) opening a digital document via the electronic operating device;
(2) highlighting and collecting text data from selected pages of the digital document through the document authentication unit to create digests and digest maps of the selected pages in order to generate document authentication data for the digital document;
(3) calculating and obtaining the digests through an irreversible unique algorithm, wherein the digest maps are utilized in a verification process to locate positions of the text data used to calculate the digests;
(4) signing the document authentication data by using a signer's digital ID, and submitting the signed document authentication data to the authentication center;
(5) sealing every authenticated page of the digital document in the authentication center; and
(6) printing the digital document with seals on authenticated pages.

16. The method of claim 15, wherein a printer is connected to the electronic operating device.

17. The method of claim 15, wherein the electronic operating devices is a personal computer, such as a notebook computer or a PDA.

18. The method of claim 15, wherein the authentication center comprises a personal computer or a computer workstation.
